(19) United States
(12) Patent Application Publication
(10) Pub. No.: US 2025/0159699 A1
(43) Pub. Date: May 15, 2025

(54) METHODS AND SYSTEMS FOR INTER-UE COORDINATION SCHEME2

(71) Applicant: Apple Inc., Cupertino, CA (US)

(72) Inventors: Chunxuan Ye, San Diego, CA (US); Haitong Sun, Cupertino, CA (US); Dawei Zhang, Saratoga, CA (US); Wei Zeng, Saratoga, CA (US); Huaning Niu, San Jose, CA (US); Sigen Ye, Whitehouse Station, NJ (US); Seyed Ali Akbar Fakoorian, San Diego, CA (US); Yushu Zhang, Beijing (CN); Hong He, San Jose, CA (US); Weidong Yang, San Diego, CA (US)

(21) Appl. No.: 18/836,548

(22) PCT Filed: Feb. 11, 2022
(86) PCT No.: PCT/CN2022/076077

§ 371 Date: Aug. 7, 2024

(51) Int. Cl. H04W 72/25; H04L 1/1829

(52) U.S. Cl. CPC H04W 72/25; H04L 1/1854

(57) ABSTRACT

A user equipment including a transceiver and a processor is disclosed. The processor is configured to receive from another UE a first sidelink control information (SCI) format payload identifying a number of resources reserved for transmission by the other UE. The processor is configured to detect, based on the received first SCI format and one or more resources selected by the UE for transmission, resource collision corresponding to one or more resources of the number of resources reserved for transmission by the other UE. The processor is configured to send, in response to the detected resource collision, a physical sidelink feedback channel (PSFCH) to the other UE for inter-UE coordination (IUC) of the number of resources reserved for transmission by the other UE.

### CROSS-REFERENCE TO RELATED APPLICATION

This application is a 35 U.S.C. § 371 application of PCT/CN2022/076077, filed on Feb. 11, 2022, and entitled “METHODS AND SYSTEMS FOR INTER-UE COORDINATION SCHEME2,” which is incorporated herein by reference as if fully disclosed herein.

### TECHNICAL FIELD

Embodiments described herein generally relate to sidelink communication between user equipments (UEs) and, more particularly, to sidelink communication used for inter-UE coordination of resource selection to avoid a resource collision in which both of the UEs select the same resource for transmission during the same time.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 depicts an example environment in which embodiments described herein may be practiced.

FIG. 2 depicts a time-based event flow describing inter-UE coordination (IUC), in accordance with some embodiments.

FIG. 3 depicts another example time-based event flow describing inter-UE coordination IUC, in accordance with some embodiments.

FIG. 4 depicts an example method flow chart for IUC, in accordance with some embodiments.

FIG. 5 depicts another example method flow chart for IUC, in accordance with some embodiments.

FIG. 6 depicts another example method flow chart for IUC, in accordance with some embodiments.

FIG. 7 depicts an example architecture of a wireless communication system of a cellular carrier domain, according to embodiments disclosed herein.

FIG. 8 depicts a system for performing signaling between a UE and a network device, according to embodiments disclosed herein.

### DETAILED DESCRIPTION

Reference will now be made in detail to representative embodiments/aspects illustrated in the accompanying drawings. It should be understood that the following description is not intended to limit the embodiments to one preferred embodiment. On the contrary, it is intended to cover alternatives, modifications, and equivalents as can be included within the spirit and scope of the described embodiments as defined by the appended claims.

Embodiments described herein include methods and apparatus (e.g., a user equipment (UE)) for performing an inter-UE coordination (IUC) procedure using a sidelink communication interface between the UEs. In particular, the embodiments described herein are related to the IUC communication. In particular, the embodiments described herein are related to a UE procedure upon detecting a resource collision based on the received resource information over a sidelink communication interface using a sidelink control information (SCI) format. The UE may receive resource information identifying resources to be used by another UE in an SCI format. The UE may then determine resource collision for one or more resources based on one or more resources to be used for transmission by the UE based on its resource configuration. The UE may then perform IUC to notify the other UE of the resource collision. Various embodiments described herein may indicate a timing and content of a notification to the other UE of the detected resource collision. Various embodiments described herein may also disclose one or more actions performed by the other UE upon receiving an indication of resource collision.

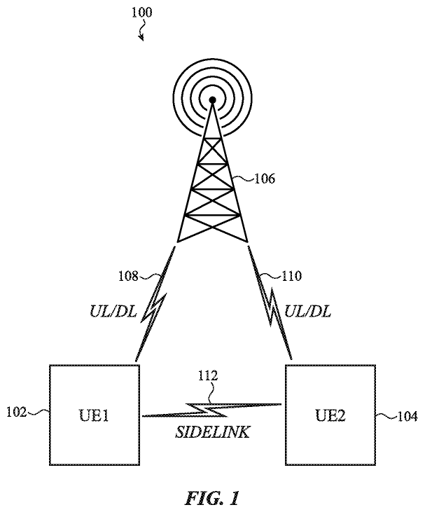

FIG. 1 depicts an example environment in which embodiments described herein may be practiced. As shown in FIG. 1, an example environment 100 may include a UE1 102, a UE2 104, and a base station 106. The base station 106 may be an access point, an eNodeB, an eNB, a gNB, etc. Though only two UEs are shown in FIG. 1, there may be more than two UEs in the example environment 100. In some embodiments, and by way of a non-limiting example, a UE may be a phone, a tablet, a smartphone, an Internet-of-Things device, a vehicle, etc. Each of the UE1 102 and the UE2 104 may be communicatively coupled with the base station 106 and may receive data in a downlink (DL) direction from the base station and may transmit data in an uplink (UL) direction. For example, as shown in FIG. 1, the UE1 may exchange data with the base station 106 in an UL direction and a DL direction over a link 108, and the UE2 may exchange data with the base station 106 in an UL direction and a DL direction over a link 110. In addition, the UE1 102 and the UE2 104 may communicate with each other using a sidelink communication interface 112, and thereby avoid communicating via the base station. In particular, as described herein, the UE1 102 and the UE2 104 may communicate with each other over the sidelink communication interface 112 for inter-UE coordination (IUC).

The IUC communication, as described in the present disclosure, may be related to exchanging resource information including one or more resources to be used by a UE over a specific period. The specific period, in some embodiments, and by way of a non-limiting example, may be (pre)configured. The IUC communication may also include notifying other UEs of any resource conflict or resource collision, such that the other UEs may take necessary action to avoid resource collision.

In some embodiments, as described herein, the inter-UE coordination may describe the resources being used by a UE for within a specific time period to another UE, so that the other UE may select its resources without causing resource collision.

In some embodiments, for example, the UE2 104 may send a request to the UE1 102 to send its resource information describing the resources being used by the UE1 102 over a specific time period. The request from the UE2 104 to the UE1 102 may be sent over the sidelink communication interface 112. The request may be sent using an SCI format or a media access control (MAC) control element. The UE1 102 may then send the requested resource information using the SCI format or as a MAC CE to the UE2 104. Based on the resource information received at the UE2 104, the UE2 104 may determine or identify that one or more resources to be used by the UE1 102 may cause resource conflict as the UE2 104 may also be using the same resource at the same time. Accordingly, the UE2 104 may then notify the UE1 102 of the resource conflict.

In some embodiments, and by way of a non-limiting example, the UE2 104 may identify a resource causing the resource conflict in the notification being sent to the UE1 102. In some embodiments, for example, the UE1 102 may determine or identify which resource is causing resource conflict based on a timing of the resource conflict notification being received by the UE1 102 from the UE2 104.

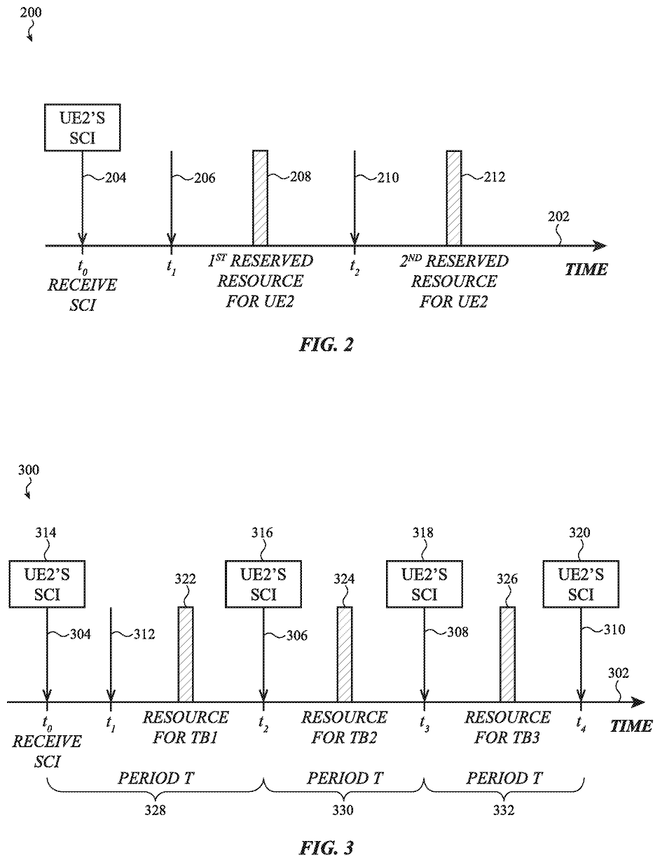

FIG. 2 depicts a time-based event flow describing inter-UE coordination (IUC), in accordance with some embodiments. As shown in the timeline 200, various events are shown along a time axis 202. For example, at time t₀ 204, an SCI format describing resource information from a UE2 104 may be received. The resource information in the SCI format received from the UE2 104 may include one or more resources that would be used by the UE2 104 over a specific period, as described herein. For example, the resource information in the SCI format may include a first resource and a second resource. The first resource may be used at a time or a time slot that may be before a time or a time slot for the second resource. In FIG. 2, the first resource and the second resource reserved for use by the UE2 104 are indicated as 208 and 212, respectively.

In some embodiments, and by way of a non-limiting example, the UE1 102, upon receiving the SCI format from the UE2 104, may determine or identify that there is a resource collision for the second resource 212. Upon detecting the resource collision for the second resource 212, the UE1 102 may send an IUC communication at time t₁ 206. The time t₁ 206 may be the scheduled time for sending the IUC communication for the UE1 102. Thus, the UE1 102 may send the IUC as long as a resource collision is detected. In some embodiments, and by way of a non-limiting example, which resource caused the resource collision may not be an important factor for the UE1 102 to send the IUC communication. Rather, after determining or identifying that a resource collision may occur, the UE1 102 may send the IUC communication to the UE2 104. Accordingly, as shown in FIG. 2, and by way of a non-limiting example, the UE1 102 may send the IUC, for example, using an SCI format payload, to the UE2 104. Thus, the IUC may be sent before a time slot corresponding to the first resource 208 when resource collision is detected by the UE1 102.

In some embodiments, and by way of a non-limiting example, upon detecting a resource collision for the second resource 212, the UE1 102 may send the IUC communication to the UE2 104 just before the reserved resource, which caused the resource collision. In the present example, the UE1 102 may send the IUC communication to the UE2 104 just before the second resource reserved for use by the UE2 104, for example, at time t₂ 210.

In some embodiments, the UE1 102 may send the IUC communication to the UE2 104 at a (pre)configured time period or predefined time period before the reserved resource which caused the resource collision. In some embodiments, and by way of a non-limiting example, the UE1 102 may send the IUC communication to the UE2 102 corresponding to the latest SCI just before the one or more reserved resources by the UE2 104 which caused the resource location. The (pre)configured or predefine time period, in one example, may be a single time period. Accordingly, as shown in FIG. 2, the UE1 102 may send the IUC communication, for example, using an SCI format payload, to the UE2 104 after a time slot corresponding to the first resource 208 but before a time slot corresponding to the second resource 212.

In some embodiments, and by way of a non-limiting example, an SCI format payload encoded and sent from the UE1 102 to the UE2 104 may be based on one or more factors including UE capabilities, a resource pool configuration of the UE, a higher layer configuration of the UE, and a specific implementation of the UE, etc. Accordingly, when to send the physical sidelink feedback channel (PSFCH) to notify another UE of the detected resource collision may be based on the one or more factors including, but not limited to, UE capabilities, a resource pool configuration of the UE, a higher layer configuration of the UE, and a specific implementation of the UE.

In some embodiments, the first resource 208 and the second resource 212 may be for the same transport block (TB) transmission. In some embodiments, the first resource 208 and the second resource 212 may be for transmission of different TBs. Whether the resources received in the SCI format from the UE2 104 at time t₀ correspond to the same TB transmission or transmission of different TBs may be determined based on a P_{rsvp_Tx} field value. A value 0 may indicate the reserved resources are for transmission of the same TB, and other values may indicate the reserved resources are for transmission of different TBs.

In some embodiments, and by way of a non-limiting example, notifying a UE of resource collision as described herein, for example, with reference to FIG. 2 and FIG. 3, may be based on a value “followSCI” set for PSDCHOccasionScheme2 field of resource pool configuration.

In some embodiments, and by way of a non-limiting example, upon receiving a notification of a resource collision at the UE2 104 from the UE1 102, a PHY layer of the UE2 104 may indicate a resource collision, or resource overlapping, of the resources reserved by the UE2 104 for use during a specific period with one or more resources reserved by the UE1 102 for during at least a portion of the specific period.

FIG. 3 depicts another example time-based event flow describing inter-UE coordination IUC, in accordance with some embodiments. As shown in the timeline 300, various events are shown along a time axis 302. For example, at time t₀ 304, time t₂ 306, time t₃ 308, and time t₄ 310, etc., an SCI format describing resource information 314, 316, 318, and 320, etc., respectively, from a UE2 104 may be received. In other words, an SCI format describing resource information including one or more resources to be used by the UE2 104 over a specific period may be received periodically, for example, at every period T 328, 330, and 332, etc.

As described herein in accordance with some embodiments, upon receiving the SCI format describing resource information including one or more resources to be used by the UE2 104 over a specific period at the UE1 102, the UE1 102 may identify or detect a resource collision corresponding to one or more resources indicated in the received SCI format from the UE2 104. Upon detecting resource collision, the UE1 102 may send an IUC communication to the UE2 104, notifying the UE2 104 of the resource collision as described herein in accordance with some embodiments.

In some embodiments, the received SCI format 314 may include a resource 322 reserved for transmission of a TB TB1, the received SCI format 316 may include a resource 324 reserved for transmission of a TB TB2, the received SCI format 318 may include a resource 326 reserved for transmission of a TB TB3, and so on. Thus, the timeline 300 shown in FIG. 3 may describe a scenario where resources are reserved for transmission of different TBs.

In some embodiments, and by way of a non-limiting example, the UE1 102 may detect a resource collision for the resource 322, and may send IUC communication to the UE2 104 upon detecting the resource collision. Whether the UE1 102 sends the IUC communication to the UE2 104, notifying the UE2 104 of the resource collision before a specific period corresponding to a time slot for the reserved resource 322, etc., may depend on one or more factors including, but not limited to, UE capabilities, a resource pool configuration of the UE, a higher layer configuration of the UE, and a specific implementation of the UE. The specific period, for example, may be one time slot period before the resource for which resource collision is detected.

In accordance with some embodiments, and by way of a non-limiting example, depending on the resource pool configuration where PSFCHOccasionScheme2 is set to “followSCI,” the UE1 102 may include one or more different physical sidelink feedback channel (PSFCH) sequences to indicate one or more resources for which resource collision is detected. Further, the detected resource collision may be for a resource reserved for transmission of different TBs. Accordingly, the UE1 102 may send an IUC communication to the UE2 104 upon detecting resource collision in which the IUC communication may be about the collided resource. For example, one PSFCH sequence (e.g., m_{cs} with value 0) may be used to indicate that all resources reserved by the UE in all subsequent periods are having resource collision, while another PSFCH sequence (e.g., mc with value 3 or 9) may indicate only a single reserved resource is having resource collision. A different value of the PSFCH sequence may be used to indicate that the single reserved resource indicated in the PSFCH sequence is the next reserved resource or the resource in the next period. In some embodiments, and by way of a non-limiting example, the PSFCH sequence value (e.g., m_{cs} with value 0 or 6) may also identify whether the resource collision is for the next reserved resource for the current or next TB transmission or for the current resource indicated in the received SCI format including the resource information for the next TB transmission.

In accordance with some embodiments, and by way of a non-limiting example, depending on the resource pool configuration where PSFCHOccasionScheme2 is set to “followReservedResource,” the UE1 102 may transmit IUC corresponding to the collided resource. Further, the collided resource may be for a resource reserved for transmission of different TBs. Upon receiving the IUC from the UE1 102 at the UE2 104, a PHY layer of the UE2 104 may report resource overlapping to a higher layer. By way of a non-limiting example, the resource overlapping may for the next reserved resource of the same TB, the next reserved one or more resources of the same TB and/or subsequent TBs, all the reserved resources of the same TB, and/or the next reserved resource of the next TB.

In some embodiments, and by way of a non-limiting example, upon receiving a resource collision notification from the UE1 102, the PHY layer of the UE2 104 may report a resource collision or resource overlapping to a higher layer of the UE2 104. The PHY layer of the UE2 104 may indicate resource overlapping for the next reserved resource of the same TB; the next reserved one or more resources of the same TB, subsequent TBs or the next TB; and/or all reserved resources of the same TB; etc.

In some embodiments, and by way of a non-limiting example, the UE2 104 may redetermine a resource for transmission of TB TB1, or consider retransmission of the TB TB1. In some embodiments, the UE2 104 may treat all periodic transmissions using the same resource as a resource collision. In other words, the UE1 102 may not determine or detect a resource collision for the resource 324, but the UE2 104 may treat the resource 324 as a resource collision. The UE2 104, upon receiving notification of a resource collision from its PHY layer, may take necessary action to avoid resource collision, including, but not limited to, determining or assigning another resource for transmission.

In some embodiments, and by way of a non-limiting example, the PSFCH sequence for IUC may be prioritized for transmission along a PSFCH sequence with HARQ, an uplink transmission, and/or sidelink transmission or reception. Prioritization of the PSFCH sequence for IUC may be based on a priority value assigned to the PSFCH sequence for IUC and a priority value assigned to the PSFCH sequence with HARQ. In some embodiments, for example, a PSFCH sequence with HARQ may take a higher priority over a PSFCH sequence for IUC. In some embodiments, and by way of a non-limiting example, prioritization of the PSFCH sequence for IUC along the PSFCH sequence with HARQ, an uplink transmission, and/or sidelink transmission or reception may be performed as described in sections 16.2.4 of TS 38.213 titled “5G; NR; Physical layer procedures for control,” version 16.2.0 dated July 2020.

Accordingly, in some embodiments, a PSFCH sequence for IUC may or may not indicate a condition type or time location of a resource conflict. Subsequently, when a UE receives a conflict indicator for resource(s) indicated by its SCI, PHY layer at a UE may exclude only the next reserved resource (or, all the resources in the slot including only the next reserved resource) indicated by the corresponding UE's SCI for current TB transmission.

In case a UE has periodic resource reservations, the PSFCH for IUC may indicate the collision of the next reserved resource indicated by the corresponding UE's SCI, no matter whether the colliding resource is for the current TB transmission as or for the next TB transmission. The advantage of this indication scheme is reusing the existing indication scheme for aperiodic resource reservation, and hence no additional PSFCH resource (i.e., PSFCH sequence) may be needed. However, this indication scheme may have the latency disadvantage, since the PSFCH for IUC may only transmitted corresponding to a UE's latest SCI before the reserved colliding resource. A UE, upon receiving this PSFCH for IUC, may reselect a resource which may be after the colliding resource.

In some embodiments, and by way of a non-limiting example, a PSFCH for IUC may indicate a collision of a current resource indicated by the corresponding SCI for the next TB transmission. The advantage of this indication scheme is that a UE may be able to learn the collision at one resource reservation period before, which may facilitate a UE's early resource (re)selection. However, a disadvantage of this indication scheme is that a new PSFCH sequence may need to be introduced, besides the existing PSFCH sequence to indicate the collision of the next reserved resource for aperiodic resource reservation.

In some embodiments, and by way of a non-limiting example, two indication schemes as described herein may be combined. Subsequently, m₀ for a resource conflict indication may be derived in the same way as specified for HARQ-ACK information in TS 38.213 Section 16.3. The sequence cyclic shift m_{cs} set to 0 may indicate a resource conflict on the next reserved resource indicated by the corresponding UE's SCI for either the current or the next TB transmission. The sequence cyclic shift m_{cs} set to 6 may indicate a resource conflict on the current resource indicated by the corresponding UE's SCI for the next TB transmission.

In some embodiments, and by way of a non-limiting example, a UE's behavior after receiving IUC may be determined as described herein. In case, if a UE has periodic resource reservation, if the received PSFCH has m_{cs}=0, a PHY layer at a UE may report resources overlapping with the next reserved resource indicated by the corresponding UE's SCI to a higher layer. If (pre)configured, the PHY layer may report resources in a slot including the next reserved resource indicated by the corresponding UE's SCI to higher layer. The higher layer at a UE may re-selects the resource(s) indicated by the conflict indicator among the S_A excluding the reported resources.

In some embodiments, and by way of a non-limiting example, if the received PSFCH has m_{cs}=6, a PHY layer at a UE may report resources overlapping with the current resource indicated by the corresponding UE's SCI for the next TB transmission to a higher layer. If (pre)configured, the PHY layer may report resources in a slot including the current resource indicated by the corresponding UE's SCI for the next TB transmission to a higher layer. The higher layer at a UE may re-selects the resource(s) indicated by the conflict indicator among the S_A excluding the reported resources.

Further, in some embodiments, a priority value of transmission of a PSFCH sequence may be set to the smallest priority value of the conflicting TBs, and the priority value of PSFCH reception for IUC may be set according to a priority value for a UE's SCI. In some embodiments, for example, a PSFCH for HARQ-ACK may be prioritized over PSFCH for IUC, while prioritization between PSFCH for IUC and LTE sidelink or uplink transmission may be according to the same rule between PSFCH for HARQ-ACK and LTE sidelink or uplink transmission.

In one example of time overlap among PSFCH for IUC with priority value 1, PSFCH for HARQ-ACK with priority value 7, and LTE sidelink with priority value 4, PSFCH for IUC may be prioritized over LTE sidelink, and LTE sidelink may be prioritized over PSFCH for HARQ-ACK, based on their respective priority values. On the other hand, PSFCH for HARQ-ACK may be prioritized over PSFCH for IUC independent of their priority values. Accordingly, following the prioritization rule as described in section 16.2.4.1 of TS 38.213, a PSFCH sequence for IUC may be prioritized and PSFCH for HARQ-ACK may be deprioritized comparing with PSFCH for IUC.

In some embodiments, when a PSFCH for IUC is prioritized after the legacy prioritization procedure between NR sidelink and LTE sidelink as in TS 38.213 Section 16.2.4.1, an additional step may be introduced to prioritize a PSFCH for HARQ-ACK in case it has time overlap with the PSFCH for IUC.

In some embodiments, for simultaneous NR sidelink and LTE sidelink Tx/Rx, if PSFCH for IUC is prioritized after the prioritization procedure in TS 38.213 Section 16.2.4.1, and the PSFCH for IUC has time overlap with PSFCH for HARQ-ACK, then PSFCH for HARQ-ACK may be prioritized. Similarly, for the prioritization between NR sidelink transmission/reception and uplink transmissions, if PSFCH for IUC is prioritized after the prioritization procedure in TS 38.213 Section 16.2.4.3.1, and this PSFCH for IUC has time overlap with PSFCH for HARQ-ACK, then PSFCH for HARQ-ACK may be prioritized.

Accordingly, in some embodiments, and by way of a non-limiting example, when there is a time overlap between a PSFCH with IUC transmission or reception, a PSFCH with HARQ transmission or reception, an uplink transmission, and/or a long-term evolution (LTE) sidelink transmission or reception, then in step 1, a prioritization between the PSFCH with IUC and the PSFCH with HARQ may be performed first. If the PSFCH with HARQ exists, the PSFCH with HARQ may be prioritized over the PSFCH with IUC, otherwise the PSFCH with IUC may be given priority. In some embodiments, by way of a non-limiting example, in step 1, instead of giving the PSFCH with HARQ a higher priority over the PSFCH with IUC, priority may be determined based on a priority value assigned to each one of them. In some embodiments, step 1 may be ignored where multiple sidelink (new radio (NR) sidelink) is considered.

In some embodiments, and by way of a non-limiting example, in step 2, the one determined to be of a higher priority in step 1 may be prioritized against the uplink transmission or the LTE transmission or reception following the legacy prioritization rule as described in section 16.2.4.1 or section 16.2.4.3.1 of TS 38.213. In step 2, in one example, a priority value of the PSFCH with HARQ may be used for prioritization or a smallest priority value of the PSFCH with HARQ and the PSFCH with IUC may be used.

In some embodiments, and by way of a non-limiting example, when there is a time overlap between a PSFCH with IUC transmission or reception, a PSFCH with HARQ transmission or reception, an uplink transmission, and/or a long-term evolution (LTE) sidelink transmission or reception, then in step 1, a prioritization between the PSFCH with IUC, the PSFCH with HARQ (or HARQ-ACK), the uplink transmission, and/or the LTE transmission or reception may be performed first using the legacy prioritization rule as described in section 16.2.4.1 to section 16.2.4.3.1 of TS 38.213. If it is determined in step 1 that the PSFCH with IUC has a priority over the PSFCH with HARQ (or HARQ-ACK), the uplink transmission, and/or the LTE transmission or reception, and the PSFCH with IUC overlaps with the PSFCH with HARQ, then the PSFCH with HARQ is prioritized over the PSFCH with IUC.

In some embodiments, and by way of a non-limiting example, when the resource pool shared by mode 1 and/or mode 2, PSFCH with IUC is deprioritized for the physical uplink control channel (PUCCH) with sidelink (SL) HARQ-ACK report.

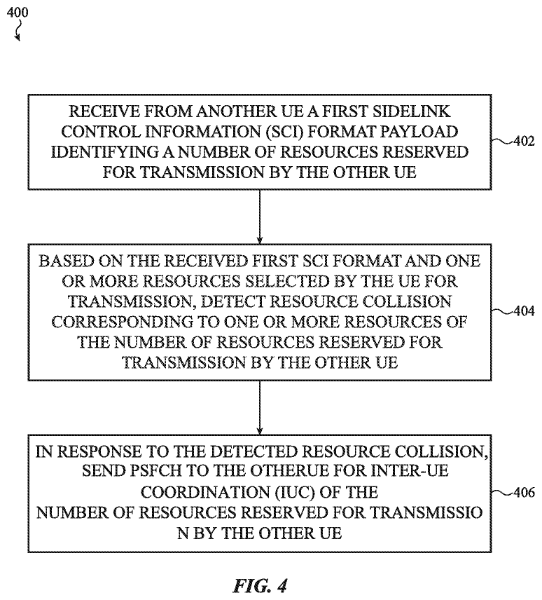

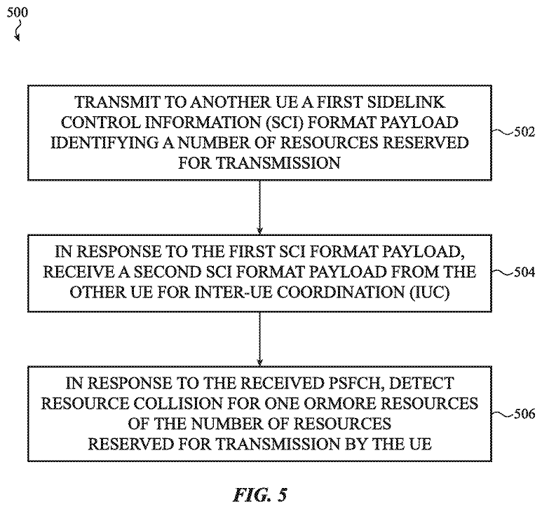

FIG. 4 depicts an example method flow chart for IUC, in accordance with some embodiments. As shown in method flow chart 400, at 402, a UE may receive from another UE a first sidelink control information (SCI) format payload identifying a number of resources reserved for transmission by the other UE. As described herein, the SCI format payload, referred to herein as a first SCI format, identifying the number of resources reserved for transmission by the UE2 104 may be received by the UE1 102 at time t₀ 204 or 304.

At 404, based on the received first SCI format and one or more resources selected by the UE for transmission, resource collision corresponding to one or more resources of the number of resources reserved for transmission by the other UE, for example, the UE2 104 may be detected by the UE, for example, the UE1 102. Detection of resource collision may be for a specific resource and/or a time slot for the specific resource, and may be according to various example embodiments described herein.

At 406, in response to the detected resource collision, an IUC may be communicated by the UE, for example, the UE1 102, to the other UE, for example, the UE2 104, for notifying the other UE of the resource collision for one or more resources reserved by the other UE for transmission. Notification to the UE2 104 from the UE1 102 may be in accordance with one or more example embodiments as described herein. In some embodiments, and by way of a non-limiting example, the IUC may be communicated as PSFCH.

FIG. 5 depicts another example method flow chart for IUC, in accordance with some embodiments. The method flow chart 400 shown in FIG. 4 is from the UE1 102 perspective, and a method flow chart 500 shown in FIG. 5 may be from the UE2 104 perspective. As shown in the method flow chart 500, at 502, a UE, for example, the UE2 104, may transmit to another UE, for example, the UE1 104, a sidelink control information (SCI) format payload identifying a number of resources reserved for transmission by the UE UE1 102. As described herein, the SCI format payload, referred to herein as a first SCI format payload, identifying the number of resources reserved for transmission by the UE2 104 may be transmitted by the UE2 104 and received by the UE1 102 at time t₀ 204 or 304.

At 504, the UE2 104 may receive PSFCH from the UE1 102. The PSFCH may be based on the first SCI format payload and one or more resources selected by the UE1 102 for transmission. The PSFCH may thus include or identify one or more resources causing resource collision.

At 506, the UE2 104 may detect one or more resources causing resource collision based on the received PSFCH. As described herein, a PHY layer of the UE2 104 may identify, detect, and report resource collision or resource overlapping of the one or more resources based on the received PSFCH to a higher layer of the UE2 104, as described herein in accordance with some embodiments. The higher layer of the UE2 104 may then take an appropriate action as described herein in accordance with some embodiments.

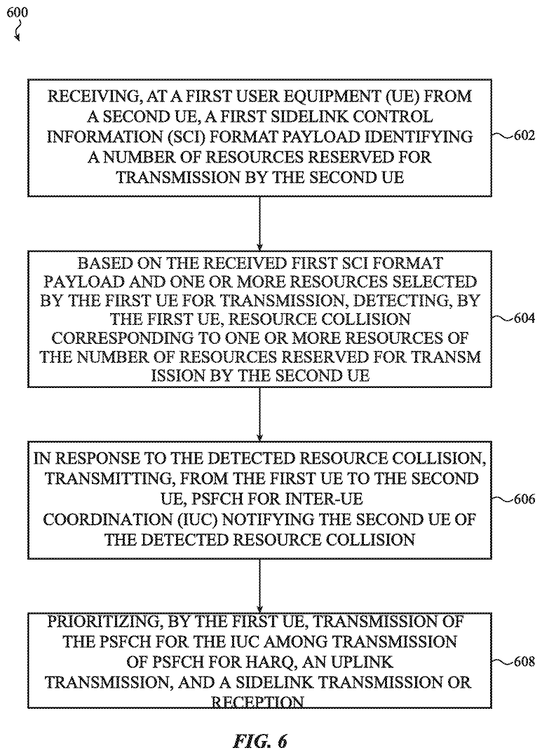

FIG. 6 depicts another example method flow chart for IUC, in accordance with some embodiments. As shown in a method flow chart 600 of FIG. 6, at 602, a first sidelink control information (SCI) format payload may be received by a first UE, for example, a UE1 102, from a second UE, for example, a UE2 104. The first SCI format payload may identify or include a number of resources reserved for transmission by the UE2 104 over a specific period.

At 604, based on the received first SCI format payload and one or more resources selected by the UE1 102 for transmission, resource collision corresponding to one or more resources of the number of resources reserved for transmission by the UE2 104 may be detected by the UE1 102. Detection of resource collision may be for a specific resource and/or a time slot for the specific resource, and may be according to various example embodiments described herein.

At 606, the UE1 102 may transmit to the UE2 104 a PSFCH for IUC notifying the UE2 104 of the detected resource collision at 604. As described herein, the PSFCH may include one or more PSFCH sequences according to some example embodiments described herein.

At 608, the UE1 102 may prioritize the PSFCH for transmission over the sidelink interface 112 to the UE2 104 along a PSFCH sequence with HARQ, an uplink transmission, and/or a sidelink transmission or reception, as described herein in accordance with some example embodiments.

Embodiments contemplated herein include an apparatus having means to perform one or more elements of the method 400, 500, or 600. In the context of method 400, 500, or 600, this apparatus may be, for example, an apparatus of a UE (such as a wireless device 802 that is a UE, as described herein).

Embodiments contemplated herein include one or more non-transitory computer-readable media storing instructions to cause an electronic device, upon execution of the instructions by one or more processors of the electronic device, to perform one or more elements of the method 400, 500, or 600. In the context of method 400, 500, or 600, this non-transitory computer-readable media may be, for example, a memory of a UE (such as a memory 806 of a wireless device 802 that is a UE, as described herein).

Embodiments contemplated herein include an apparatus having logic, modules, or circuitry to perform one or more elements of the method 400, 500, or 600. In the context of method 400, 500, or 600, this apparatus may be, for example, an apparatus of a UE (such as a wireless device 802 that is a UE, as described herein).

Embodiments contemplated herein include an apparatus having one or more processors and one or more computer-readable media, using or storing instructions that, when executed by the one or more processors, cause the one or more processors to perform one or more elements of the method 400, 500, or 600. In the context of method 400, 500, or 600, this apparatus may be, for example, an apparatus of a UE (such as a wireless device 802 that is a UE, as described herein).

Embodiments contemplated herein include a signal as described in or related to one or more elements of the method 400, 500, or 600.

Embodiments contemplated herein include a computer program or computer program product having instructions, wherein execution of the program by a processor causes the processor to carry out one or more elements of the method flow of FIGS. 4, 5, and/or 6. In the context of method flows of FIGS. 4, 5, and/or 6, the processor may be a processor of a UE (such as a processor(s) 804 of a wireless device 802 that is a UE, as described herein), and the instructions may be, for example, located in the processor and/or on a memory of the UE (such as a memory 806 of a wireless device 802 that is a UE, as described herein.

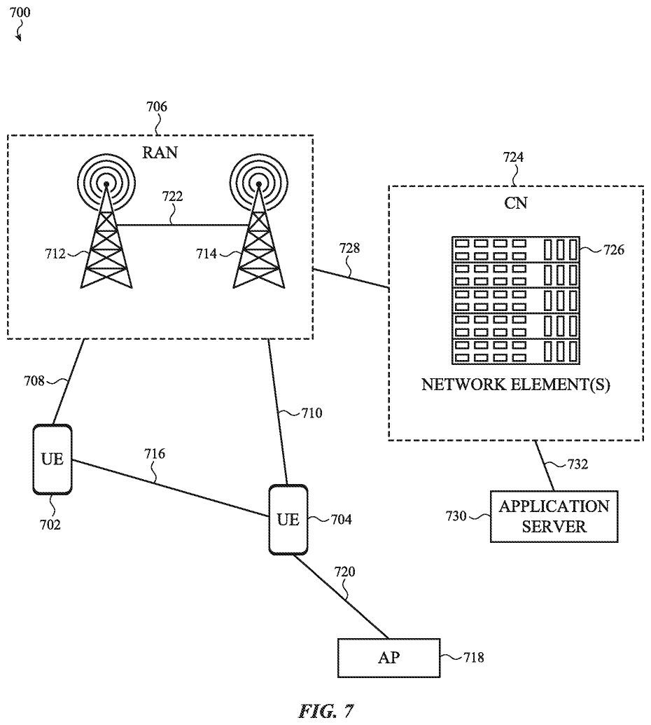

FIG. 7 depicts an example architecture of a wireless communication system of a cellular carrier domain, according to embodiments disclosed herein. The following description is provided for an example wireless communication system 700 that operates in conjunction with the LTE system standards and/or 5G or NR system standards, and/or future standards for 6G, and so on, as provided by 3GPP technical specifications.

As shown by FIG. 7, the wireless communication system 700 includes a UE 702 and a UE 704 (although any number of UEs may be used). In this example, the UE 702 and the UE 704 are illustrated as smartphones (e.g., handheld touchscreen mobile computing devices connectable to one or more cellular networks) but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling and may be consistent with one or more radio access technologies (RATs) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

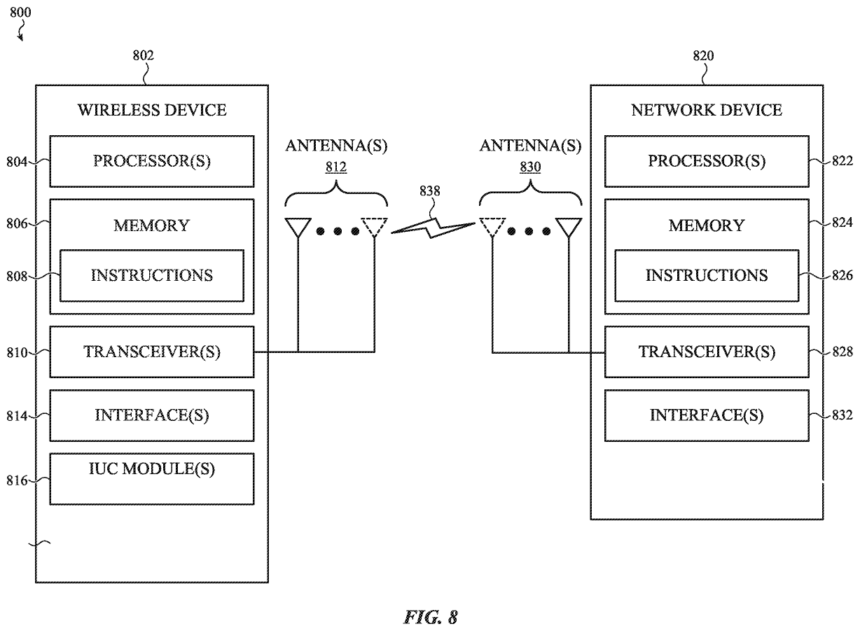

FIG. 8 depicts a system for performing signaling between a UE and a network device, according to embodiments disclosed herein. A system 800 may be a portion of a wireless communications system as herein described. The wireless device 802 may be, for example, a UE of a wireless communication system. The network device 820 may be, for example, a base station or an access point connected to a wireless communication system via wired or wireless communication links.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 838) to and/or from the wireless device 802 with other devices (e.g., the network device 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments, the wireless device 802 (e.g., a UE) may communicate with the network device 820 (e.g., a base station or an access point). The wireless device 802 may communicate with the access point via the antennas 812, and the access point may communicate with the network device 820 via a wired or wireless connection.

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include an inter-UE communication module 816 configured to perform various embodiments for inter-UE communication as described herein. The inter-UE communication module 816 may be implemented via hardware, software, or combinations thereof. For example, the inter-UE communication module 816 may be implemented as a processor, circuit, and/or instructions 808 stored in the memory 806 and executed by the processor(s) 804. In some examples, the inter-UE communication module 816 may be integrated within the processor(s) 804 and/or the transceiver(s) 810. For example, the inter-UE communication module 816 may be implemented by a combination of software components (e.g., executed by a DSP or a general processor) and hardware components (e.g., logic gates and circuitry) within the processor(s) 804 or the transceiver(s) 810.

The network device 820 may include one or more processor(s) 822. The processor(s) 822 may execute instructions such that various operations of the network device 820 are performed, as described herein. The processor(s) 822 may include one or more baseband processors implemented using, for example, a CPU, a DSP, an ASIC, a controller, an FPGA device, another hardware device, a firmware device, or any combination thereof configured to perform the operations described herein.

The network device 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The network device 820 may include one or more transceiver(s) 828 that may include RF transmitter and/or receiver circuitry that use the antenna(s) 830 of the network device 820 to facilitate signaling (e.g., the signaling 838) to and/or from the network device 820 with other devices (e.g., the wireless device 802) according to corresponding RATs. In certain embodiments, the signaling 838 may occur via a wired or a wireless network.

The network device 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The network device 820 may include one or more interface(s) 832. The interface(s) 832 may be used to provide input to or output from the network device 820. For example, a network device 820 that is a base station may include interface(s) 832 made up of transmitters, receivers, and other circuitry (e.g., other than the transceiver(s) 828/antenna(s) 830 already described) that enables the base station to communicate with other equipment in a core network, and/or that enables the base station to communicate with external networks, computers, databases, and the like for purposes of operations, administration, and maintenance of the base station or other equipment operably connected thereto.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

What is claimed is:

1. A user equipment (UE), comprising:
a transceiver; and
a processor configured to:
receive from a second UE a first sidelink control information (SCI) format payload identifying a number of resources reserved for transmission by the second UE;
based on the received first SCI format payload and one or more resources selected by the UE for transmission, detect resource collision corresponding to the one or more resources of the number of resources reserved for transmission by the second UE; and
in response to the detected resource collision, send a physical sidelink feedback channel (PSFCH) to the second UE for inter-UE coordination (IUC) of the number of resources reserved for transmission by the second UE.

2. The UE of claim 1, wherein the number of resources reserved for transmission by the second UE includes a first reserved resource and a second reserved resource, and wherein the detected resource collision for the second reserved resource, and the second reserved resource is used for transmission of a transport block (TB) later in time after the first reserved resource.

3. The UE of claim 2, wherein the processor is further configured to send the PSFCH to the second UE before the first reserved resource in response to the detected resource collision.

4. The UE of claim 2, wherein the processor is further configured to send the PSFCH to the second UE after the first reserved resource and before the second reserved resource.

5. The UE of claim 2, wherein the first reserved resource and the second reserved resource each is used for transmission of a same TB or different TBs.

6. The UE of claim 2, wherein the processor is further configured to send the PSFCH to the second UE for IUC a (pre)configured or predefined number of periods before the second reserved resource for which the resource collision is detected.

7. The UE of claim 6, wherein the (pre)configured or predefined number of periods is one period.

8. The UE of claim 1, wherein the processor is further configured to build and send a physical sidelink feedback channel (PSFCH) sequence according to the detected resource collision and the PSFCH to the second UE for the IUC.

9. The UE of claim 8, wherein the PSFCH sequence identifies at least one resource of the number of resources for which the resource collision is detected in more than one period.

10. The UE of claim 9, wherein the PSFCH sequence identifies a resource of the number of resources in a next transmission period, or a reserved resource of the number of resources by the second UE.

11. The UE of claim 8, wherein the processor is further configured to prioritize the PSFCH sequence for the IUC with the PSFCH sequence for HARQ, an uplink transmission, and a long-term evolution (LTE) sidelink transmission or reception.

12. The UE of claim 11, wherein to prioritize the PSFCH sequence for the IUC, the processor is further configured to:
determine a higher priority among the PSFCH sequence for the IUC, the PSFCH sequence for HARQ, the uplink transmission, and the LTE sidelink transmission or reception; and
in response to determining that the PSFCH sequence for the IUC has the highest priority, and the PSFCH sequence for IUC overlaps with the PSFCH for HARQ, prioritize the PSFCH for HARQ over the PSFCH for IUC.

13. The UE of claim 1, wherein sending of the PSFCH to the second UE for the IUC is performed based on one or more of: UE capabilities, a higher layer configuration of the UE, a resource pool configuration at the UE, and a specific implementation of the UE.

14. A user equipment (UE), comprising:
a transceiver; and
a processor configured to:
transmit to a second UE a first sidelink control information (SCI) format payload identifying a number of resources reserved for transmission;
in response to the first SCI format payload, receive a physical sidelink feedback channel (PSFCH) from the second UE for inter-UE coordination (IUC); and
in response to the received PSFCH, detect resource collision for one or more resources of the number of resources reserved for transmission by the UE.

15. The UE of claim 14, wherein the number of resources reserved for transmission includes a first reserved resource and a second reserved resource, the second reserved resource is used for transmission of a transport block (TB) later in time after the first reserved resource.

16. The UE of claim 15, wherein the resource collision for the one or more resources of the number of resources reserved for transmission by the UE corresponds to a time slot of a resource for which the resource collision is detected.

17. A method, comprising:
receiving, at a first user equipment (UE) from a second UE, a first sidelink control information (SCI) format payload identifying a number of resources reserved for transmission by the second UE;
based on the received first SCI format payload and one or more resources selected by the first UE for transmission, detecting, by the first UE, resource collision corresponding to the one or more resources of the number of resources reserved for transmission by the second UE;
in response to the detected resource collision, transmitting, from the first UE to the second UE, a PSFCH for inter-UE coordination (IUC) notifying the second UE of the detected resource collision; and
prioritizing, by the first UE, transmission of the PSFCH for the IUC along transmission of HARQ, an uplink transmission, and a sidelink transmission or reception.

18. The method of claim 17, wherein the number of resources reserved for transmission by the second UE includes a first reserved resource and a second reserved resource, and wherein the resource collision is detected for the second reserved resource, the second reserved resource is used for transmission of a transport block (TB) later in time after the first reserved resource.

19. The method of claim 18, wherein transmitting the PSFCH for the IUC comprises transmitting the PSFCH to the second UE before the first reserved resource in response to detecting the resource collision.

20. The method of claim 18, wherein transmitting the PSFCH for the IUC comprises transmitting the PSFCH to the second UE after the first reserved resource and before the second reserved resource.
